(19) United States
(12) Patent Application Publication
(10) Pub. No.: US 2026/0123741 A1
(43) Pub. Date: May 7, 2026

(54) ELECTRONIC DEVICE SUPPORT MECHANISM

(71) Applicant: Shenzhen Leaderment Technology Co.,Ltd., Shenzhen City (CN)

(72) Inventor: Chunbin Li, Shenzhen (CN)

(21) Appl. No.: 19/001,294

(22) Filed: Dec. 24, 2024

(30) Foreign Application Priority Data
Nov. 5, 2024 (CN) 202422697603.3
Nov. 5, 2024 (CN) 202422698974.3
Nov. 5, 2024 (CN) 202422712576.2

(51) Int. Cl. A45F 5/00; F16B 47/00; F16M 13/02

(52) U.S. Cl. CPC A45F 5/1516; F16B 47/00; F16M 13/022; A45F 2005/006; F16M 2200/08

(57) ABSTRACT

Disclosed is an electronic device support mechanism, including a housing, a support structure and a connecting mechanism. The support structure is overturned and/or rotated relative to the housing by the connecting mechanism, the housing includes an inner panel, a bottom plate and a magnetic suction member, the magnetic suction member is arranged on the inner panel, and the inner panel is embedded in the bottom plate provided with a plurality of suction cups. The support structure is overturned and/or rotated relative to the housing by the connecting mechanism, so that multi-angle support is achieved; the magnetic suction member is placed on the inner panel, so that the electronic device is fixed by magnetic suction; and the suction cups are provided on the bottom plate, and the support mechanism is adsorbed on any flat surface, so that supporting the electronic device in multiple scenarios is achieved.

### CROSS REFERENCE TO RELATED APPLICATION

This application claims priority benefit of Chinese patent Application No. 202422712576.2, filed on Nov. 5, 2024, No. 202422698974.3, filed on Nov. 5, 2024, No. 202422697603.3, filed on Nov. 5, 2024, and the entire contents of which are incorporated herein by reference.

### TECHNICAL FIELD

The present invention relates to the technical field of support structures, and in particular, to an electronic device support mechanism.

### BACKGROUND

Electronic devices are one of the most popular devices at present and are increasingly indispensable in people's daily lives. An electronic device support structure can prevent people from suffering from cervical spondylosis for the sake of comfort, allowing users to use electronic devices more comfortably or conveniently to free their hands. This electronic device support structure can meet various usage scenarios of users.

At present, most suction cup support structures on the market are just simple magnetic suction cups with adhesive or magnets on the front and suction cups on the back. However, since only suction cups are equipped, the suction cup support structures can only be fixed on a flat surface for use and cannot be placed on a desktop to support the electronic devices, which is difficult to meet the requirements of users to use the support structure in multiple scenarios.

### SUMMARY

A primary objective of the present invention is to provide an electronic device support mechanism, which aims to adapt to multiple scenarios to meet the requirement of supporting electronic devices.

To achieve the above objective, the present invention provides an electronic device support mechanism, which includes a housing, a support structure and a connecting mechanism for connecting the housing and the support structure, wherein the housing includes a bottom plate and a top plate forming a cavity, an inner panel and a magnetic suction member are provided in the housing, the magnetic suction member is arranged on one side of the inner panel close to the top plate, a first accommodating groove is provided on an outer surface of one side of the bottom plate far away from the magnetic suction member, a plurality of suction cups are provided on a periphery of the first accommodating groove, and the support structure is arranged in the first accommodating groove and may be overturned and/or rotated relative to the housing by the connecting mechanism to form an included angle between the support structure and the housing for supporting the housing.

In an embodiment, the inner panel is provided with a first groove, the first groove is communicated with the first accommodating groove, the connecting mechanism is arranged in the first groove, and the connecting mechanism is fixed with the inner panel.

In an embodiment, the connecting mechanism includes a turnover assembly, the turnover assembly includes a first fixing member and a first rotating shaft, the first rotating shaft passes through the support structure and the first fixing member, and the support structure is overturned relative to the first fixing member by the first rotating shaft.

In an embodiment, the connecting mechanism further includes a rotating assembly, the rotating assembly includes a chuck, the chuck is provided with a first clamping member, the first clamping member is clamped with the inner panel, and the turnover assembly is rotatably connected to the chuck.

In an embodiment, the rotating assembly further includes a second fixing member fixedly connected to the first fixing member, and the second fixing member is provided with a clamping portion, and one end of the clamping part passes through the chuck and is rotatably connected to the chuck.

In an embodiment, the rotating assembly further includes an elastic unit, a part of the elastic unit is arranged in the second fixing member, the chuck is provided with a plurality of clamping grooves, and the elastic unit abuts against the clamping grooves.

In an embodiment, the elastic unit includes a spring and an elastic piece, the elastic piece is clamped in a coil gap of the spring, one end of the spring is positioned in the second fixing member, and the other end of the spring abuts against the chuck; and the support structure is rotated to drive the second fixing member to rotate and press the spring to move the elastic unit in the chuck, and the spring is reset to clamp the elastic unit in the clamping groove.

In an embodiment, the elastic piece is provided with an abutting portion and a supporting portion connected to each other, the second fixing member is provided with a second groove, the supporting portion is positioned in the second groove, and the abutting portion extends out of the second groove.

In an embodiment, the first fixing member and the second fixing member are integrally formed.

In an embodiment, the rotating assembly further includes a clamping ring arranged on one side of the chuck far away from the turnover assembly, the clamping ring is provided with an opening, and the clamping ring is clamped into the clamping portion by the opening.

In an embodiment, the rotating assembly further includes a washer, the chuck is provided with a third groove, the washer is positioned in the third groove, and a pressing surface of the washer abuts against the second fixing member.

In an embodiment, the support structure is a support plate.

In an embodiment, the support structure is a support plate.

In an embodiment, the support structure is a finger ring holder.

In an embodiment, the support structure is a finger ring holder.

In an embodiment, the finger ring holder includes a first finger ring and a second finger ring, the first finger ring is connected to the first rotating shaft, the second finger ring is rotatably connected to the first finger ring, and the first finger ring is sleeved outside of the second finger ring.

In an embodiment, the first accommodating groove penetrates through the bottom plate, a second accommodating groove is formed in a position of the inner panel opposite to the first accommodating groove, the second accommodating groove is communicated with the first groove, the finger ring holder is received in the first accommodating groove and the second accommodating groove, and an outer surface of the received finger ring holder does not exceed an outer surface of the housing.

In an embodiment, the electronic device support mechanism further includes a hanging rope, and the hanging rope is connected to the housing.

In an embodiment, the electronic device support mechanism further includes a hanging buckle, and the hanging buckle is connected to the hanging rope.

In an embodiment, an annular groove for placing the magnetic suction member is provided in the inner panel, and the magnetic suction member is an annular magnet.

According to the present invention, the support structure is overturned and/or rotated relative to the housing by the connecting mechanism, so that the electronic device support mechanism can achieve multi-angle support; the magnetic suction member is placed on the inner panel, so that the electronic device is fixed by magnetic suction; and a plurality of suction cups are provided on the bottom plate, and the electronic device support mechanism can be adsorbed on any flat surface, so that the requirement of supporting the electronic device in multiple scenarios is achieved.

### BRIEF DESCRIPTION OF DRAWINGS

To more clearly illustrate the technical solutions in the embodiments of the present invention or in the prior art, the drawings required to be used in the description of the embodiments or the prior art are briefly introduced below. It is clear that the drawings in the description below are some embodiments of the present invention, and those of ordinary skill in the art can obtain other drawings according to the mechanisms illustrated in these drawings without creative efforts.

FIG. 1 is a schematic diagram of a closed state of an embodiment of an electronic device support mechanism;

FIG. 2 is a schematic diagram of an exploded state of an embodiment of an electronic device support mechanism;

FIG. 3 is a diagram of an exploded state of an embodiment of an electronic device support mechanism from another angle;

FIG. 4A is a cross-sectional view of an embodiment of an electronic device support mechanism; FIG. 4B is a partially enlarged view of A in FIG. 4A;

FIG. 5 is a schematic diagram of a closed state of another embodiment of an electronic device support mechanism;

FIG. 6A is a schematic diagram of an exploded state of another embodiment of an electronic device support mechanism; FIG. 6B is a partially enlarged view of FIG. 6A;

FIG. 7A is a cross-sectional view of another embodiment of an electronic device support mechanism; FIG. 7B is a partially enlarged view of C in FIG. 7A;

FIG. 8A is a schematic diagram of a structure of a connecting mechanism from an angle; FIG. 8B is a schematic diagram of a structure of a connecting mechanism from another angle;

FIG. 9A is a schematic diagram of a structure of a chuck from an angle; FIG. 9b is a schematic diagram of a structure of a chuck from another angle;

FIG. 10 is a schematic diagram of the structures of a first fixing member and a second fixing member;

FIG. 11 is a schematic diagram of a closed state of another embodiment of an electronic device support mechanism;

FIG. 12 is a schematic diagram of an exploded state of another embodiment of an electronic device support mechanism; and

FIG. 13 is a schematic diagram of an expanded state of another embodiment of an electronic device support mechanism.

### DESCRIPTIONS OF REFERENCE NUMERALS

1: housing, 10: top plate, 11: inner panel, 111: first groove, 112: second accommodating groove, 113: annular groove, 12: bottom plate, 121: first accommodating groove, 13: magnetic suction member, 2: support structure, 21: support plate, 22: finger ring holder, 221: first finger ring, 2211: first connecting portion, 222: second finger ring, 2221: second connecting portion, 223: second rotating shaft, 3: connecting mechanism, 31: turnover assembly, 311: first fixing member, 312: first rotating shaft, 32: rotating assembly, 321: second fixing member, 3211: clamping portion, 3212: second groove, 322: chuck, 3221: first clamping member, 3222: clamping groove, 3223: third groove, 323: elastic unit, 3231: spring, 3232: elastic piece, 32321: abutting portion, 32322: supporting portion, 324: clamping ring, 3241: opening, 325: washer, 4: suction cup, 5: hanging rope, and 6: finger ring.

The realization of the objectives, the functional features, and the advantages of the present invention will be further explained in conjunction with the embodiments and with reference to the drawings.

### DETAILED DESCRIPTION OF EMBODIMENTS

The following clearly and completely describes the technical solutions in the embodiments of the present invention with reference to drawings in the embodiments of the present invention. It is clear that the described embodiments are merely a part rather than all of the embodiments of the present invention. All other embodiments obtained by those of ordinary skill in the art based on embodiments of the present invention without creative efforts shall fall within the protection scope of the present invention.

It should be noted that, if directional indications (such as upper, lower, left, right, front and rear) are involved in the embodiments of the present invention, the directional indications are only used to explain the relative positional relationships, the motion situations and the like between individual components under a certain pose (as shown in the drawings), and if the certain pose is changed, the directional indications are changed accordingly.

In addition, if there are descriptions relating to “first”, “second” and the like in the embodiments of the present invention, the descriptions of “first”, “second” and the like are for descriptive purposes only and are not to be construed as indicating or implying relative importance thereof or implicitly indicating the quantities of the indicated technical features. Thus, a feature defined by “first” or “second” may explicitly or implicitly include at least one such feature. In addition, “and/or” appearing herein is meant to include three parallel solutions, and taking “A and/or B” as an example, it includes solution A, or solution B, or both solution A and solution B. In addition, the technical solutions among various embodiments may be combined with each other, however, this combination must be based on that it can be realized by those of ordinary skill in the art. When the combination of the technical solutions is contradictory or cannot be realized, such a combination of the technical solutions should not be considered to exist, and is not within the protection scope of the present invention.

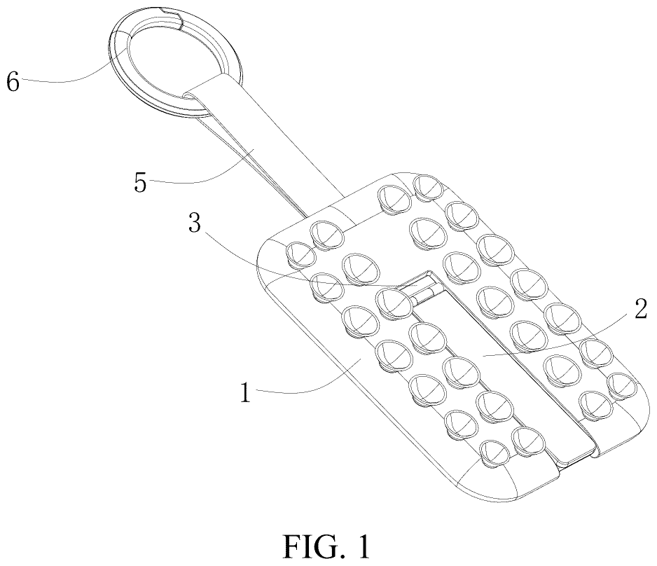

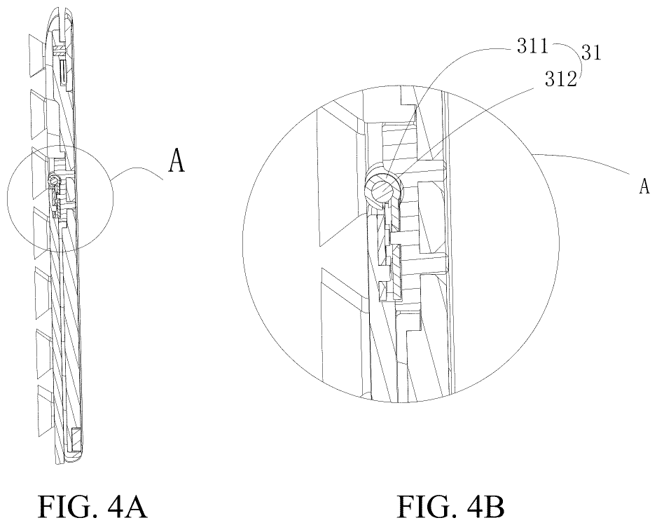

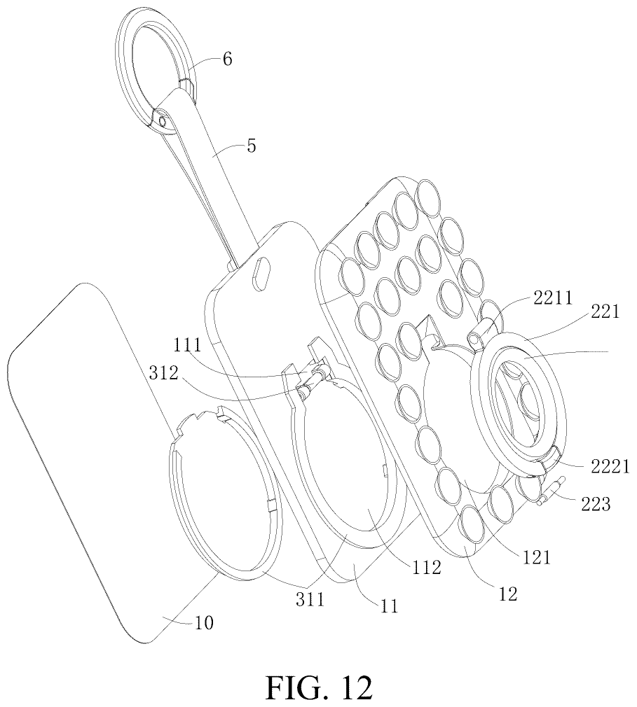

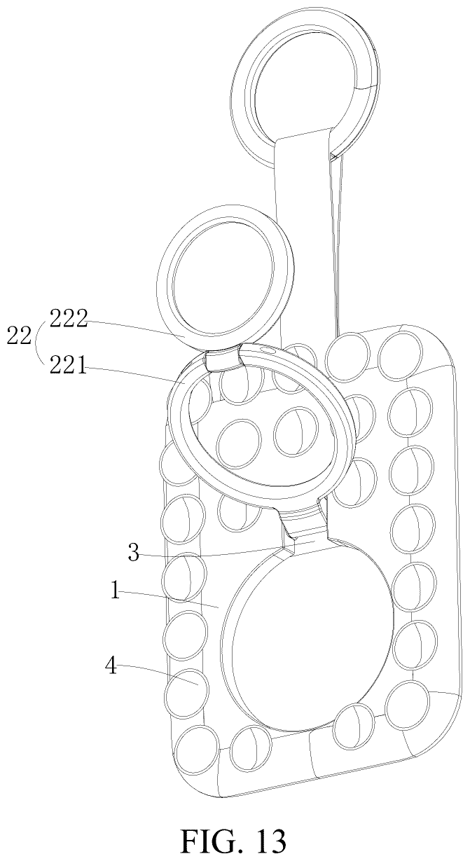

As shown in FIGS. 1-13, the present invention provides an electronic device support mechanism, which includes a housing 1, a support structure 2 and a connecting mechanism 3, wherein the housing 1 includes a bottom plate 12 and a top plate 10 forming a cavity, an inner panel 11 and a magnetic suction member 13 are provided in the housing 1, the magnetic suction member 13 is arranged on one side of the inner panel 11 close to the top plate 10, a first accommodating groove 121 is provided on an outer surface of one side of the bottom plate 12 far away from the magnetic suction member 13, a plurality of suction cups 4 are provided on a periphery of the first accommodating groove 121, and the support structure 2 is arranged in the first accommodating groove 121 and may be overturned and/or rotated relative to the housing 1 by the connecting mechanism 3 to form an included angle between the support structure 2 and the housing 1 for supporting the housing 1.

In the embodiment of the present invention, the support structure 2 is overturned and/or rotated relative to the housing 1 by the connecting mechanism 3, so that the electronic device support mechanism can achieve multi-angle support; the magnetic suction member 13 is provided in the housing 1, the magnetic suction member 13 is placed on one side of the inner panel 11 and the top panel 10, so that one side of the top panel 10 has magnetic properties, and the electronic device is fixed by magnetic suction; and a plurality of suction cups 4 are provided on the bottom plate 12, and the electronic device support mechanism can be adsorbed on any flat surface, so that the requirement of supporting the electronic device in multiple scenarios is achieved.

The electronic device referred to may be a mobile phone, a tablet, and the like. When the magnetic suction function is implemented, a matching magnetic suction structure needs to be provided on the electronic device. The electronic device support mechanism has a magnetic suction member 13 on the front side, which can be fixed to the electronic device or the back side of a protective housing of the electronic device by the magnetic suction function. The housing 1 may be made of plastic, metal, wood, leather, and the like, which is not limited herein.

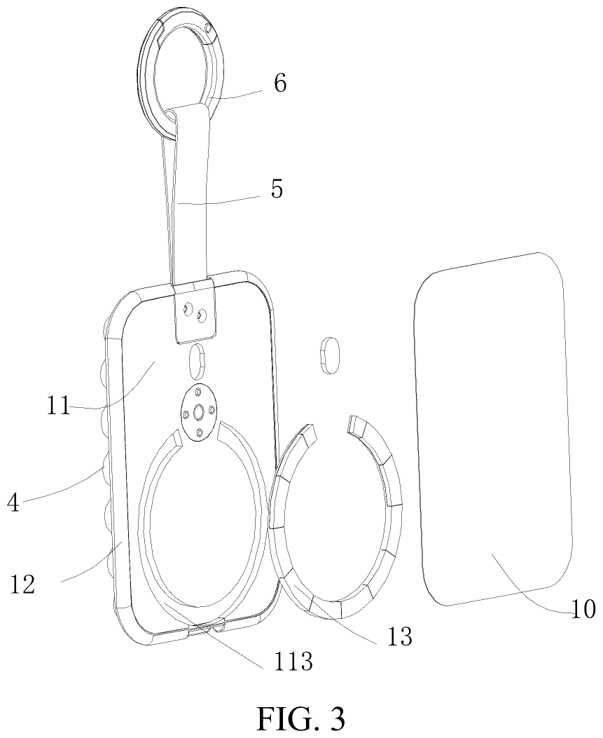

As shown in FIG. 3, an annular groove 113 for placing the magnetic suction member 13 is provided in the inner panel 11, and the magnetic suction member 13 is an annular magnet. The inner panel 11 is provided with the annular groove 113 for placing a magnet, so that the magnetic suction member 13 is fixed, and the magnetic suction member 13 is prevented from moving. The inner panel 11 is tightly attached to the top plate 10, which is favorable for ensuring the magnetic strength. In other possible embodiments, the magnet may be arranged in a square-shaped accommodating groove. One or more magnetic suction members 13 may be provided. Preferably, more magnetic suction members are arranged to ensure the magnetism of the electronic device support mechanism.

The suction cup 4 and the bottom plate 12 may be integrally provided, or the suction cup 4 is fixed to the bottom housing by gluing or other methods. A plurality of suction cups 4 may be provided, and the plurality of suction cups 4 are evenly distributed on a periphery of the first accommodating groove 121. The suction cup 4 is a bowl-shaped or dish-shaped suction cup 4, which can effectively contact the adsorbed surface to form a relatively sealed space; and the suction cup 4 is used to discharge the internal air when pressed, so as to be adsorbed on the surface of the adsorbed object. The suction cup 4 may be made of rubber, polyvinyl chloride, polyurethane, and the like.

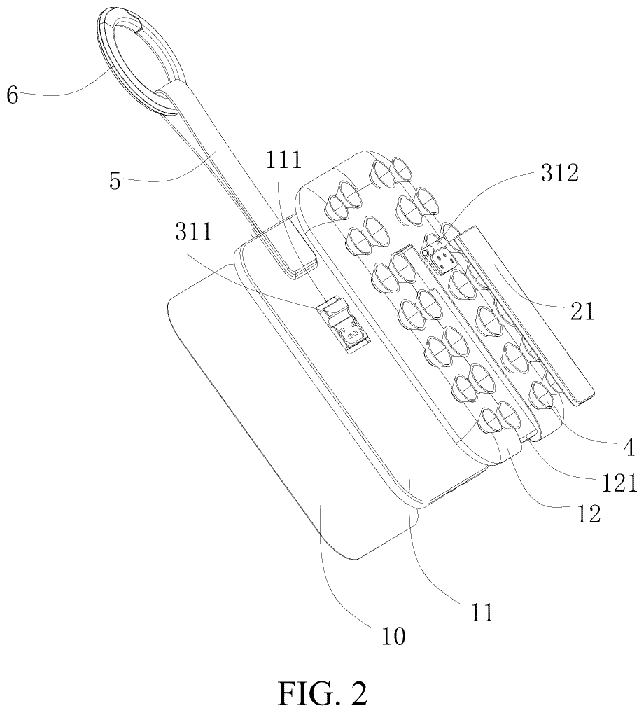

As shown in FIGS. 2, 6A, and 12, a first accommodating groove 121 is provided on the bottom plate 12, and the first accommodating groove 121 is used to place the received support structure 2, so that the use of the suction function of the suction cup 4 is not affected after the support structure 2 is received, and meanwhile, the volume of the electronic device support mechanism in this embodiment has a smaller volume and is convenient to receive and carry. The received support structure 2 referred to herein means that the support structure 2 is not unfolded for use, that is, in a closed state. The structure of the first accommodating groove 121 is matched with the support structure 2. If the support structure 2 is cylindrical, the first accommodating groove 121 is cylindrical; and if the support structure 2 is strip-shaped or plate-shaped, the corresponding first accommodating groove 121 may be strip-shaped or plate-shaped. This is not specifically limited herein.

Further, the inner panel 11 is provided with a first groove 111, the first groove 111 is communicated with the first accommodating groove 121, the connecting mechanism 3 is arranged in the first groove 111, the connecting mechanism 3 is fixed with the inner panel 11, and the first groove 111 can be used to help the connecting mechanism 3 keep a correct trajectory during movement. The shape of the first groove 111 is related to the connecting mechanism 3, for example, the first groove 111 may be square, oval, round, irregular, and the like. This is not specifically limited herein.

The following describes the relevant embodiments in combination with the specific connecting mechanism 3, the support structure 2 and other related structures.

### Embodiment 1

As shown in FIGS. 1-4B, in this embodiment, on the basis of the foregoing description, the connecting mechanism 3 includes a turnover assembly 31, the turnover assembly 31 includes a first fixing member 311 and a first rotating shaft 312, the first rotating shaft 312 passes through the support structure 2 and the first fixing member 311, and the support structure 2 is overturned relative to the first fixing member 311 by the first rotating shaft 312.

The first fixing member 311 may be a sheet-shaped fixing member or a circular fixing member, or may be in an irregular shape, and the first groove 111 is matched with the first fixing member. The first rotating shaft 312 is fixedly connected to the first fixing member 311, and the support structure 2 is rotatably connected to the first rotating shaft 312 to adjust the angle of the support structure 2. The first fixing member 311 is arranged in the first groove 111, and the connection between the first fixing member and the first groove 111 may be welding by a fixing structure such as a pin and a fastener. The structure of the first fixing member 311 should not be limited thereto.

As shown in FIGS. 1-4B, the first fixing member 311 is a sheet-shaped structure, the first groove 111 is in a square shape matching with the first groove, and the first fixing member 311 is provided with a connecting column to be clamped on the inner panel 11.

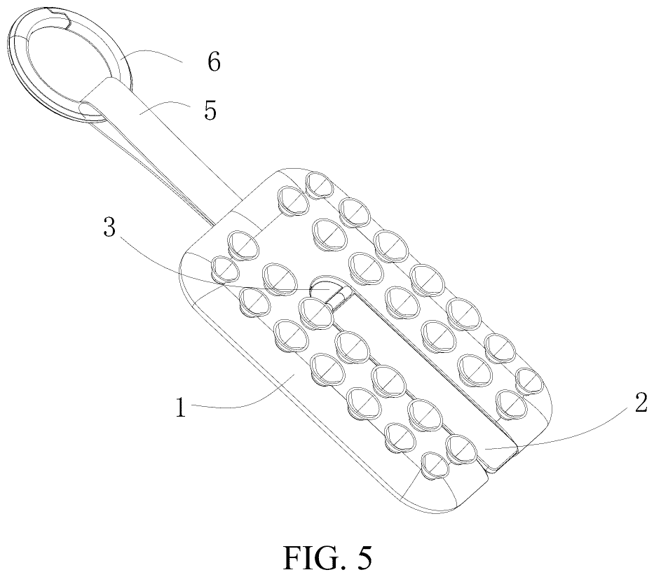

As shown in FIGS. 5-10, the first fixing member 311 is an annular structure, the first groove 111 is in an annular shape matching with the first fixing member, and the first fixing member 311 is connected to the inner panel 11 by other structures.

As shown in FIGS. 11-13, the first fixing member 311 is in an irregular shape.

The turnover assembly 31 may adjust the viewing angle of the electronic device based on a requirement, so as to provide a more comfortable viewing experience suitable for different usage scenarios, such as watching videos, video calls or reading; the turnover assembly 31 may enable the support structure 2 to be folded when not in use, which saves space and is convenient to carry and store; and the gravity center of the support structure 2 can be changed during overturning, so that the electronic device can be kept stable at various angles and is not prone to tipping over. Some designs allow the support structure 2 to be overturned to achieve different usage modes, for example, switching from a landscape screen to a portrait screen to meet different application requirements. The turnover assembly 31 may be freely overturned by about 0-150 degrees, so that the electronic device support mechanism can support the electronic device at multiple angles on a desktop, and can also be clamped on a product with a certain thickness for use, such as a computer screen, by adjusting the angle, and the flexibility and the freedom are good.

### Embodiment 2

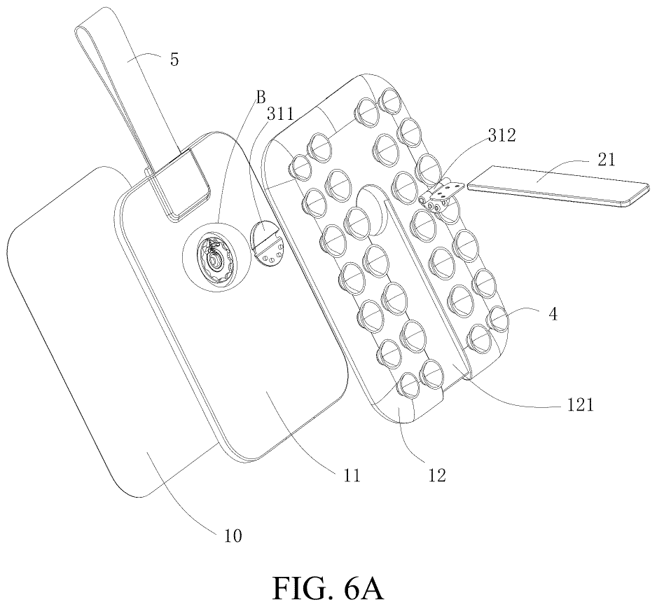

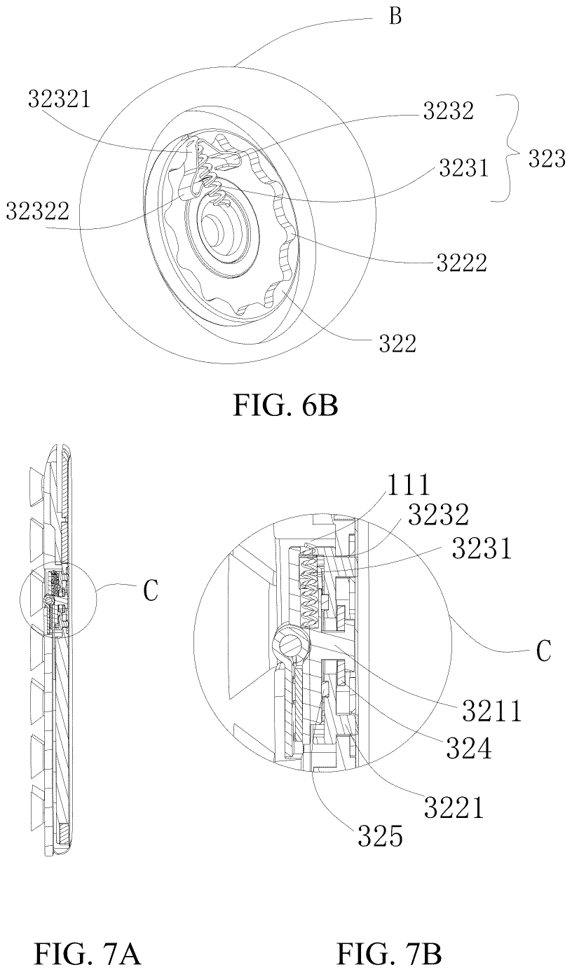

In this embodiment, as shown in FIGS. 6A-10, based on Embodiment 1, the connecting mechanism 3 further includes a rotating assembly 32, the rotating assembly 32 includes a chuck 322, the chuck 322 is provided with a first clamping member 3221, the first clamping member 3221 is clamped with the inner panel 11, and the turnover assembly 31 is rotatably connected to the chuck 322.

The first clamping member 3221 is used to connect the chuck 322 to the inner panel 11, and one or more first clamping member 3221 may be provided, which may be connecting posts provided on the chuck 322 and passing through the inner panel 11 and clamped with the inner panel 11. The rotating assembly 32 is provided, and the turnover assembly 31 is rotated relative to the chuck 322 to achieve the rotation of the support assembly, thereby achieving the adjustment of different rotation angles of the support structure 2 to meet different application scenarios.

It should be noted that, since the turnover assembly 31 is rotated relative to the chuck 322, in this embodiment, the shape and size of the first groove 111 should meet the rotation of the turnover assembly 31.

Specifically, the rotating assembly 32 further includes a second fixing member 3211 fixedly connected to the first fixing member 311, and the second fixing member 3211 is provided with a clamping portion 3211, and the clamping portion 3211 passes through the chuck 322 and rotatably connects the first fixing member 311 to the chuck 322.

The clamping portion 3211 is formed by extending the second fixing member 321 to one side of the chuck 322, a through hole corresponding to the clamping portion 3211 is formed in the chuck 322, the chuck 322 is arranged in the clamping portion 3211, and the second fixing member 321 is rotatably connected to the chuck 322 by the clamping portion 3211.

The rotating assembly 32 may easily adjust the viewing angle of the electronic device, and the rotating assembly 32 can rotate the support structure 2 by 360 degrees, so that the adjustable angle range is increased; the support structure 2 can be kept stable at various angles by rotating the rotating assembly 32, which reduces the risk of the electronic device falling or tipping over; and the rotating assembly 32 enables the support structure 2 to adapt to the requirements and preferences of different users, which increases the practicality of the product.

Further, as shown in FIGS. 6B, 7B, and 8B, the rotating assembly 32 further includes an elastic unit 323, a part of the elastic unit 323 is arranged in the second fixing member 3211, the chuck 322 is provided with a plurality of clamping grooves 3222, and the elastic unit 323 abuts against the clamping grooves 3222. The elastic unit 323 includes a spring 3231 and an elastic piece 3232, the elastic piece 3232 is clamped in a coil gap of the spring 3231, one end of the spring 3231 is positioned in the second fixing member 3211, and the other end of the spring 3231 abuts against the chuck 322; and the support structure 2 is rotated to drive the second fixing member 3211 to rotate and press the spring 3231 to move the elastic unit 323 in the chuck 322, and the spring 3231 is reset to clamp the elastic unit 323 in the clamping groove 3222.

The spring 3231 can provide the support structure 2 with the necessary spring force to maintain a certain tension when the support structure is rotated. This tension ensures that the support structure 2 is stably fixed in the desired position in use; the elastic piece 3232 can be used as a buffer element to absorb impact during rotation, reduce vibration, and protect the support structure 2 from being damaged. The elastic piece 3232 may limit the rotation range of the support structure 2, so as to ensure that the support structure 2 does not exceed a predetermined angle, thereby avoiding damage caused by over-rotation. The combination of the spring 3231 and the elastic piece 3232 makes the user easier to adjust the angle of the support structure 2 without additional tools or complicated operations, thereby improving convenience of use.

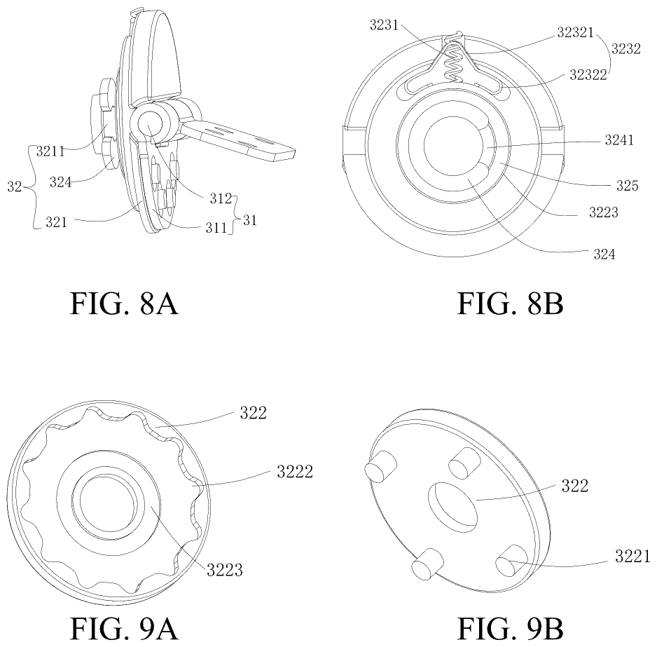

Referring to FIG. 8B, the elastic piece 3232 is provided with an abutting portion 32321 and a supporting portion 32322 connected to each other, the second fixing member 3211 is provided with a second groove 3213, the supporting portion 32322 is positioned in the second groove 3213, and the abutting portion 32321 extends out of the second groove 3213. The abutting portion 32321 and the supporting portion 32322 of the elastic piece 3232 can limit the rotation range of the support structure 2, so that the support structure 2 is prevented from exceeding a predetermined angle, and damage caused by excessive rotation is avoided. The elastic piece 3232 cooperates with the second groove 3213, so that the support structure 2 can be automatically fixed at a desired position after rotation and is not prone to rebound.

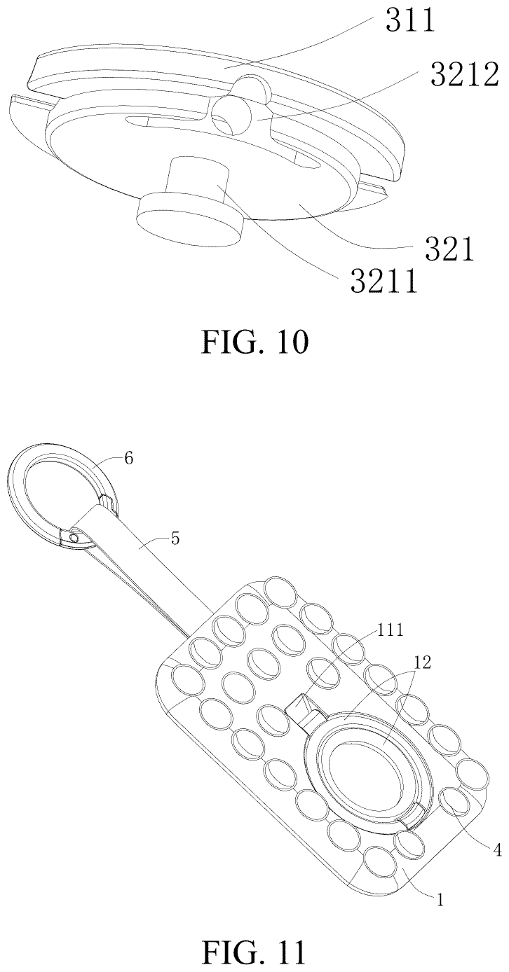

Referring to FIG. 10, in this embodiment, the first fixing member 311 and the second fixing member 321 are integrally formed, and the first fixing member 311 and the second fixing member 321 may be made of plastic or metal, preferably metal. In other embodiments, the first fixing member 311 and the second fixing member 321 may be two different parts connected by welding, gluing, screw locking, and the like.

As shown in FIG. 8A and B, preferably, the rotating assembly 32 further includes a clamping ring 324, the clamping ring 324 is provided with an opening 3241, and the clamping ring 324 is clamped into the clamping portion 3211 by the opening 3241. The height between the accessories of the rotating assembly 32 is adjusted, which can effectively control the center of gravity of the entire device, ensure that the device is not prone to tipping over during use, and provide better stability. Reasonable height distribution can make the load more evenly distributed on the support structure 2, reduce local stress, and thus extend the service life of the accessories.

Preferably, referring to FIGS. 7B, 8B and 9A, the rotating assembly 32 further includes a washer 325, the chuck 322 is provided with a third groove 3223, the washer 325 is partially positioned in the third groove 3223, and a pressing surface of the washer 325 abuts against the second fixing member 3211.

The washer 325 can effectively reduce the impact caused by rotation, play a role in shock absorption and buffering, and protect the integrity of the device and accessories. The washer 325 forms a layer of isolation between the contact surface of the chuck 322 and the second fixing member 3211, which reduces friction and wear and extends the service life of the electronic device support mechanism. The washers 325 of different thicknesses are provided to adjust the gap between accessories to meet specific mounting requirements or solve poor fit; and the washers 325 can help disperse the load, improve the stability of accessories, and reduce the impact of looseness or vibration.

In this embodiment, the support structure 2 may be overturned and rotated relative to the housing 1 by the turnover assembly 31 and the rotating assembly 32 in the connecting mechanism 3, so that the all-round angle adjustment can be achieved. No matter in the horizontal direction or the vertical direction, a user can adjust the electronic device to a suitable angle based on a requirement. For example, when watching a video, the user can adjust the electronic device to a comfortable tilt angle, and when making a video call, the user can rotate the electronic device to a suitable direction, which greatly improves the user experience.

### Embodiment 3

In this embodiment, as shown in FIGS. 1, 2, 5 and 6A, the support structure 2 is defined as a support plate 21, and the support plate 21 is rotatably connected to the first rotating shaft 312 by a fixing structure. Specifically, the support plate 21 may be combined with the connecting mechanism 3 of Embodiment 1 or Embodiment 2, so as to achieve the turnover of the support plate, or achieve the turnover and rotation of the support plate.

Specifically, when the support structure 2 is a support plate 21, the first accommodating groove 121 arranged on the bottom plate 12 is in a strip shape matched with the bottom groove. The thickness of the first accommodating groove 121 may be greater than or equal to that of the support plate 21, so that the support plate 21 does not exceed the outer surface of the bottom plate 12 when being received in the first accommodating groove 121. Alternatively, in other embodiments, the thickness of the first accommodating groove 121 is slightly less than that of the support plate 21, so that the support plate 21 is received in the first accommodating groove 121 and partially protrudes out of the first accommodating groove 121, but the protruding portion does not affect the use of the suction cup 4. The thickness of the support plate 21 may be 1-20 mm, preferably 1-10 mm, so as to ensure that the thickness of the bottom plate 12 is not too thick, thereby affecting the weight and volume of the electronic device support mechanism.

### Embodiment 4

In this embodiment, referring to FIGS. 11-13, the support structure 2 is defined as a finger ring holder 22, and the finger ring holder 22 is rotatably connected to the first rotating shaft 312. Specifically, the finger ring holder 22 may be combined with the connecting mechanism 3 of Embodiment 1 or Embodiment 2, so as to achieve the turnover of the finger ring holder, or achieve the turnover and rotation of the finger ring holder.

When the support structure 2 is the finger ring holder 22, the first accommodating groove 121 arranged on the bottom plate 12 is in a circular shape matched with the finger ring holder.

Specifically, in this embodiment, the finger ring holder 22 includes a first finger ring 221 and a second finger ring 222, the first finger ring 221 is connected to the first rotating shaft 312, the second finger ring 222 is rotatably connected to the first finger ring 221, and the first finger ring 221 is sleeved outside of the second finger ring 222. In other embodiments, the finger ring holder 22 may be a single finger ring or three or more finger rings connected to each other.

Specifically, a first connecting portion 2211 may be provided on the first finger ring 221, and the finger ring holder 22 may be rotatably connected to the first rotating shaft 312 by the first connecting portion 2211. The second finger ring 222 is provided with a second connecting portion 2221, the finger ring holder 22 further includes a second rotating shaft 223, the second rotating shaft 223 passes through the second connecting portion 2221, the second finger ring 222 is provided with a concave portion (not shown), the concave portion and the second connecting portion 2221 are arranged oppositely, two ends of the second rotating shaft 223 are connected to the first finger ring 221, and the second finger ring 222 is overturned relative to the first finger ring 221 by the second rotating shaft 223.

As shown in FIG. 11, since the thickness of the finger ring holder 22 is greater than that of the support plate 21, especially a double-ring holder 22 structure having the first finger ring 221 and the second finger ring 222, in this case, if only the bottom plate 12 is provided with the first accommodating groove 121 to place the finger ring holder 22, the bottom plate 12 is required to have a larger thickness, the first accommodating groove 121 can penetrate through the bottom plate 12, a second accommodating groove 112 is provided at a position of the inner panel 11 opposite to the first accommodating groove 121, the second accommodating groove 112 is communicated with the first groove 111, the finger ring holder 22 is received in the first accommodating groove 121 and the second accommodating groove 112, and the outer surface of the received ring support 22 does not exceed the outer surface of the housing, thereby ensuring the normal use of the suction function of the suction cup 4.

The electronic device support mechanism with the finger ring holder 22 can achieve supporting and provide an additional holding point for the finger ring holder 22, so that a user can hold the electronic device more firmly, and the risk of accidental falling is reduced.

Furthermore, the two finger rings can be pulled out when the finger ring holder 222 with the double-ring rotating shaft is used, and the finger rings can be freely overturned, so that the product can be supported at multiple angles when being placed on a table, and the flexibility and the freedom are good.

### Embodiment 5

In this embodiment, other structures of the solution of the present invention are defined, which may be further defined on the basis of any one of Embodiments 1-4.

As shown in FIGS. 1, 5 and 11, the electronic device support mechanism further includes a hanging rope 4, and one end of the hanging rope 4 is connected to the housing 1. The hanging rope 4 allows the electronic device support mechanism to be conveniently hung on a bag, belt or wrist, which improves the convenience of carrying and is suitable for outdoor or travel use. The electronic device support mechanism is fixed in a certain position by the hanging rope 4, which can effectively prevent accidental falling or loss, ensuring that the electronic device support mechanism is always at hand. The hanging rope 4 can be fixed inside the housing 1 by a locking method by a fixing member, or can pass through a through hole on the housing 1 by a slipknot.

### Embodiment 6

As shown in FIGS. 1, 5 and 11, this embodiment is a further optimized solution to Embodiment 5. In this embodiment, a hanging buckle 5 is sleeved at the other end of the hanging rope 4.

The hanging buckle 5 can be used to hang other accessories, such as keys or small tools, which increases the versatility of the support structure 2 and improves the user experience.

The above mentioned contents are only optional embodiments of the present invention and are not intended to limit the patent scope of the present invention, and under the inventive concept of the present invention, the equivalent mechanism transformations made by using the contents of the specification and the drawings of the present invention, or direct/indirect applications to other related technical fields, are all included in the patent protection scope of the present invention.

1. An electronic device support mechanism, comprising: a housing, a support structure and a connecting mechanism for connecting the housing and the support structure, wherein the housing comprises a bottom plate and a top plate forming a cavity, an inner panel and a magnetic suction member are provided in the housing, the magnetic suction member is arranged on one side of the inner panel close to the top plate, a first accommodating groove is provided on an outer surface of one side of the bottom plate far away from the magnetic suction member, a plurality of suction cups are provided on a periphery of the first accommodating groove, and the support structure is arranged in the first accommodating groove and is overturned and/or rotated relative to the housing by the connecting mechanism to form an included angle between the support structure and the housing for supporting the housing.

2. The electronic device support mechanism according to claim 1, wherein the inner panel is provided with a first groove, the first groove is communicated with the first accommodating groove, the connecting mechanism is arranged in the first groove, and the connecting mechanism is fixed with the inner panel.

3. The electronic device support mechanism according to claim 2, wherein the connecting mechanism comprises a turnover assembly, the turnover assembly comprises a first fixing member and a first rotating shaft, the first rotating shaft passes through the support structure and the first fixing member, and the support structure is overturned relative to the first fixing member by the first rotating shaft.

4. The electronic device support mechanism according to claim 3, wherein the connecting mechanism further comprises a rotating assembly, the rotating assembly comprises a chuck, the chuck is provided with a first clamping member, the first clamping member is clamped with the inner panel, and the turnover assembly is rotatably connected to the chuck.

5. The electronic device support mechanism according to claim 4, wherein the rotating assembly further comprises a second fixing member fixedly connected to the first fixing member, and the second fixing member is provided with a clamping portion, and one end of the clamping part passes through the chuck and is rotatably connected to the chuck.

6. The electronic device support mechanism according to claim 5, wherein the rotating assembly further comprises an elastic unit, a part of the elastic unit is arranged in the second fixing member, the chuck is provided with a plurality of clamping grooves, and the elastic unit abuts against the clamping grooves.

7. The electronic device support mechanism according to claim 6, wherein the elastic unit comprises a spring and an elastic piece, the elastic piece is clamped in a coil gap of the spring, one end of the spring is positioned in the second fixing member, and the other end of the spring abuts against the chuck; and the support structure is rotated to drive the second fixing member to rotate and press the spring to move the elastic unit in the chuck, and the spring is reset to clamp the elastic unit in the clamping groove.

8. The electronic device support mechanism according to claim 7, wherein the elastic piece is provided with an abutting portion and a supporting portion connected to each other, the second fixing member is provided with a second groove, the supporting portion is positioned in the second groove, and the abutting portion extends out of the second groove.

9. The electronic device support mechanism according to claim 8, wherein the first fixing member and the second fixing member are integrally formed.

10. The electronic device support mechanism according to claim 6, wherein the rotating assembly further comprises a clamping ring arranged on one side of the chuck far away from the turnover assembly, the clamping ring is provided with an opening, and the clamping ring is clamped into the clamping portion by the opening.

11. The electronic device support mechanism according to claim 6, wherein the rotating assembly further comprises a washer, the chuck is provided with a third groove, the washer is positioned in the third groove, and a pressing surface of the washer abuts against the second fixing member.

12. The electronic device support mechanism according to claim 3, wherein the support structure is a support plate.

13. The electronic device support mechanism according to claim 11, wherein the support structure is a support plate.

14. The electronic device support mechanism according to claim 3, wherein the support structure is a finger ring holder.

15. The electronic device support mechanism according to claim 11, wherein the support structure is a finger ring holder.

16. The electronic device support mechanism according to claim 14, wherein the finger ring holder comprises a first finger ring and a second finger ring, the first finger ring is connected to the first rotating shaft, the second finger ring is rotatably connected to the first finger ring, and the first finger ring is sleeved outside of the second finger ring.

17. The electronic device support mechanism according to claim 14, wherein the first accommodating groove penetrates through the bottom plate, a second accommodating groove is formed in a position of the inner panel opposite to the first accommodating groove, the second accommodating groove is communicated with the first groove, and the finger ring holder is received in the first accommodating groove and the second accommodating groove.

18. The electronic device support mechanism according to claim 3, wherein the electronic device support mechanism further comprises a hanging rope, and the hanging rope is connected to the housing.

19. The electronic device support mechanism according to claim 18, wherein the electronic device support mechanism further comprises a hanging buckle, and the hanging buckle is connected to the hanging rope.

20. The electronic device support mechanism according to claim 1, wherein an annular groove for placing the magnetic suction member is provided in the inner panel, and the magnetic suction member is an annular magnet.
